(19) United States
(12) Patent Application Publication
(10) Pub. No.: US 2022/0111466 A1
(43) Pub. Date: Apr. 14, 2022

(54) Laser scanning ablation synthesis of medium-entropy and high-entropy particles with size from nanometer to micrometer

(71) Applicant: NANJING UNIVERSITY, Nanjing (CN)

(72) Inventors: Zhigang Zou, Nanjing (CN); Bing WANG, Nanjing (CN); Yingfang YAO, Nanjing (CN); Congping WU, Nanjing (CN)

(73) Assignee: Nanjing University, Nanjing (CN)

(21) Appl. No.: 17/092,218

(22) Filed: Nov. 7, 2020

(30) Foreign Application Priority Data
Oct. 14, 2020 (CN) 202011094113.4

(51) Int. Cl. B23K 26/361; B23K 26/082; B23K 26/402

(52) U.S. Cl. CPC B23K 26/361; B82Y 40/00; B23K 26/402; B23K 26/082

(57) ABSTRACT

A method for scaled-up synthesis of medium-entropy and high-entropy nanoparticles (NPs) including alloys and ceramics on various substrates such as carbon, metal and glass. The method requires only two steps to synthesize these NPs, including loading metal salt precursors with equal molar ratio onto a support and irradiating the support by highly intense laser pulses in liquid at ambient atmosphere. The method ensures multiple (3˜9) atoms to combine without segregation regardless of their mutual solubility. The method can easily tailor the particle size from nanometer to micrometer by controlling the parameters.

### BACKGROUND

### Field of Invention

The present disclosure relates to nanotechnology, and particularly to a method of synthesizing medium-entropy and high-entropy nanoparticles (NPs) using laser scanning ablation.

### Description of Related Art

Medium-entropy and high-entropy NPs including alloy NPs and ceramics NPs have attracted considerable attention due to its unique configuration and promising properties such as high strength, unique electrical and magnetic properties, and promising resistances to wear, oxidation and corrosion. The controllable synthesis of medium-entropy and high-entropy NPs has tremendous application merits in many fields such as thermoelectricity, dielectric, catalysis, and energy storage, yet remains a challenge due to the lack of robust strategies. Synthesis of these NPs has been achieved by a few methods such as carbothermal shock and moving bed pyrolysis. However, these techniques only produce HEA NP, but not HEC NP. They require inert atmosphere and high temperature which are only applied to thermally-resistant substrates rather than thermally-sensitive substrates. Thus, a method of synthesizing medium-entropy and high-entropy NPs with broad substrate applicability under mild conditions is desired.

### SUMMARY OF THE INVENTION

A laser scanning ablation (LSA) method of synthesizing medium-entropy and high-entropy NPs includes loading metal salt precursors with equal molar ratio onto a support and irradiating the support by highly intense laser pulses in liquid at ambient atmosphere.

The LSA method allows the synthesis of impurity-free medium-entropy and high-entropy NPs with thermodynamically forbidden composition and uniform elemental distributions. The size of particles within a range from several nanometers to micrometers can be kinetically controlled by the ablation parameters as well as liquid temperature. The method allows medium-entropy and high-entropy NPs loaded onto various substrates such as carbon materials, glass and metals. The LSA method of synthesizing medium-entropy and high-entropy NPs has the advantages of simple operation, low cost, mild reaction condition, high efficiency and environmental protection.

### BRIEF DESCRIPTION OF THE DRAWINGS

FIG. 1 An SEM image of (AuFeCoCuCr) HEA-NPs loaded on carbon nanofibers (CNFs) prepared in Example 1 with the scale bar of 100 nm. A TEM image of a AuFeCoCuCr HEA NP with the scale bar of 20 nm and the corresponding Energy-dispersive X-ray spectroscopy (EDS) maps of Au, Fe, Co, Cu, Cr elements.

FIG. 2 A TEM image of (PtAuPdCuCrSnFeCoNi) HEA-NPs prepared in Example 2 and the EDS maps of Pt, Au, Pd, Cu, Cr, Sn, Fe, Co, Ni elements. Scale bar, 20 nm.

FIG. 3 XRD pattern of novenary (PtAuPdCuCrSnFeCoNi) HEA-NPs prepared in Example 2.

FIG. 4 An SEM of (PtAuPdFeCo) HEA NPs on carbonized wood prepared in Example 3 with the scale bar of 100 μm and the EDS maps of Pt, Au, Pd, Fe, Co elements with the scale bar of 1 μm.

FIG. 5 A TEM image of (PtIrCuNiCr) HEA NPs on graphene prepared in Example 4 with the scale bar of 50 nm and the EDS maps of Pt, Ir, Cu, Ni, Cr elements with the scale bar of 10 nm.

FIG. 6 An LSV curve of two-electrode cell assembled by bifunctional PtIrCuNiCr-graphene electrocatalysts as both cathode and anode.

FIG. 7 An SEM of (PtAuFeCoNi) HEA NPs on copper foam prepared in Example 5 with the scale bar of 10 μm and the EDS maps of Pt, Au, Fe, Co, Ni elements with the scale bar of 0.5 μm.

FIG. 8 An SEM of (AuPdCuSnZn) HEA NPs on glass prepared in Example 6 with the scale bar of 1 μm and the EDS maps of Au, Pd, Cu, Sn, Zn elements with the scale bar of 100 nm.

FIG. 9 An SEM of (CuCrFeCoNiS) HEC NPs on CNFs prepared in Example 7 with the scale bar of 100 nm and the EDS maps of Cu, Cr, Fe, Co, Ni, S elements with the scale bar of 50 nm.

FIG. 10 An SEM of (CuCrFeCoNiO) HEC NPs on CNFs prepared in Example 8 with the scale bar of 100 nm and the EDS maps of Cu, Cr, Fe, Co, Ni, O elements with the scale bar of 50 nm.

FIG. 11 A TEM image of medium-alloy PtAuCu NPs on carbon nanofibers prepared in Example 9 with the scale bar of 200 nm and the EDS maps of Pt, Au, Cu elements with the scale bar of 100 nm.

### DETAILED DESCRIPTION OF THE EMBODIMENTS

Exemplary embodiments relate to a method of synthesizing medium-entropy and high-entropy nanoparticles. Preferred embodiments are described in detail below.

### Example 1

The present patent discloses a laser ablation method of synthesizing medium-entropy and high-entropy NPs, which includes the following steps:

(1) Chloroauric acid, ferric chloride, cobalt chloride, copper chloride and chromium chloride were dissolved in ethanol with 0.01 M for each metallic element. The mixed solution was directly dropped onto the carbon nanofiber prepared by electrostatic spinning with a loading of ˜1 ml/cm². Then the loaded substrates were transferred to a vacuum oven for drying.

(2) The carbon nanofiber in step (1) was transferred to a beaker containing hexane (the liquid level was about 1 cm from the bottom of the beaker), and a nanosecond pulse laser with a pulse width of 5 ns was used to scan the surface of the carbon nanofiber. The average laser power density was 2×10⁵ W/cm² and the frequency was 20 kHz.

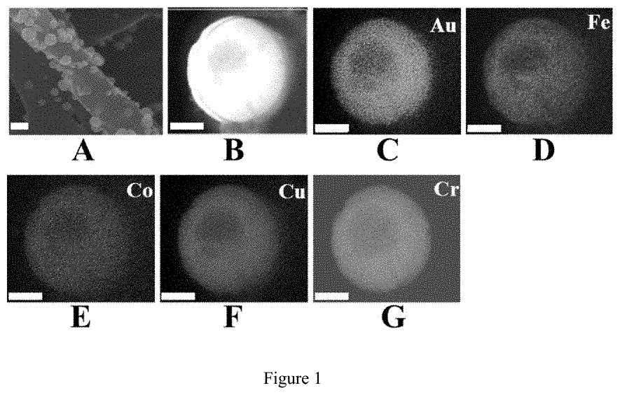

As shown in the micrographs of FIG. 1, the elements of gold, iron, cobalt, copper and chromium are uniformly dispersed among the high-entropy alloy NPs synthesized from Example 1, while the alloy particles are uniformly distributed on the surface of carbon nanofiber. The average particle size of the high-entropy alloy NPs synthesized in Example 1 is about 70 nm.

### Example 2

Example 2 differs from Example 1 in that it includes the following steps:

(1) Chloroplatinic acid, chloroauric acid, palladium chloride, nickel chloride, ferric chloride, cobalt chloride, copper chloride, chromium chloride, and tin chloride were dissolved in ethanol with 0.01 M for each metallic element. The mixed solution was directly dropped onto the carbon nanofiber prepared by electrostatic spinning with a loading of ˜1 ml/cm². Then the loaded substrates were transferred to a vacuum oven for drying.

(2) The carbon nanofiber in step (1) was transferred to a beaker containing hexane (the liquid level was about 1 cm from the bottom of the beaker), and a nanosecond pulse laser with a pulse width of 5 ns was used to scan the surface of the carbon nanofiber. The average laser power density was 2×10⁵ W/cm² and the frequency was 20 kHz.

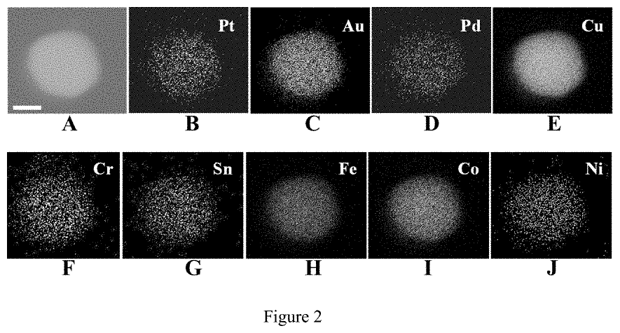

As shown in the micrographs of FIG. 2, the elements of platinum, gold, palladium, iron, cobalt, nickel, copper, chromium, tin are uniformly dispersed among the high-entropy alloy NPs synthesized from Example 2. The average particle size of the high-entropy alloy NPs synthesized in Example 2 is about 50 nm.

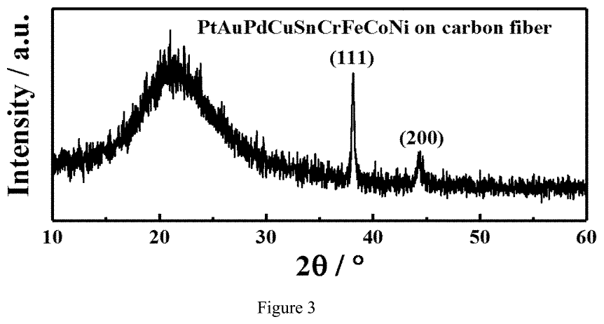

As shown in the XRD pattern of FIG. 3, the high entropy alloy NPs synthesized in Example 2 were assigned to face-centered cubic structure.

### Example 3

Example 3 differs from Example 1 and 2 in that it includes the following steps:

(1) Chloroplatinic acid, chloroauric acid, palladium chloride, ferric chloride, and cobalt chloride were dissolved in ethanol with 0.01 M for each metallic element. The mixed solution was directly dropped onto a carbonized block (length×width×height=3 cm×3 cm×0.4 cm) with a loading of ˜1 ml/cm². Then the loaded block was transferred to a vacuum oven for drying.

(2) The block in step (1) was transferred to a beaker containing hexane (the liquid level was about 1 cm from the bottom of the beaker), and a nanosecond pulse laser with a pulse width of 5 ns was used to scan the surface of the block. The average laser power density was 2×10⁵ W/cm² and the frequency was 30 kHz.

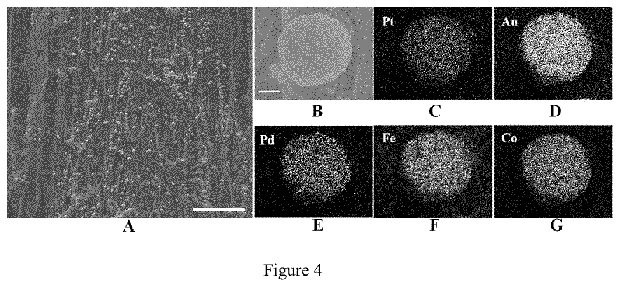

As shown in the micrographs of FIG. 4, the elements of platinum, gold, palladium, iron and cobalt are uniformly dispersed among the high-entropy alloy particles synthesized from Example 3, while the alloy particles are uniformly distributed on the surface of block. The average particle size of the high-entropy alloy NPs synthesized in Example 3 is about 2˜3 micrometer.

### EXAMPLE

Example 4 differs from Example 1, 2 and 3 in that it includes the following steps:

(1) Chloroplatinic acid, iridium chloride, copper chloride, nickel chloride, and chromium chloride were dissolved in ethanol with 0.01 M for each metallic element. The mixed solution was directly dropped onto graphene with a loading of ˜0.1 ml/mg. Then the loaded graphene was transferred to a vacuum oven for drying.

(2) The precursors-loaded graphene was transferred in a baker containing hexane. Then the solution was irradiated under agitation with the laser for 30 min. The average laser power density was 2×10⁵ W/cm² and the frequency was 30 kHz.

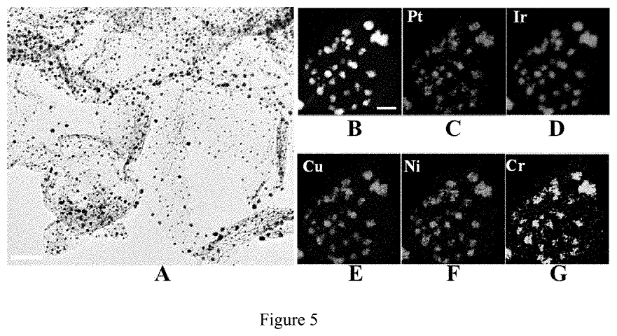

As shown in the micrographs of FIG. 5, the elements of platinum, iridium, copper, nickel, chromium are uniformly dispersed among the high-entropy alloy NPs synthesized from Example 4, while the alloy particles are uniformly distributed on graphene. The average particle size of the high-entropy alloy NPs synthesized in Example 4 is about 5 nanometers.

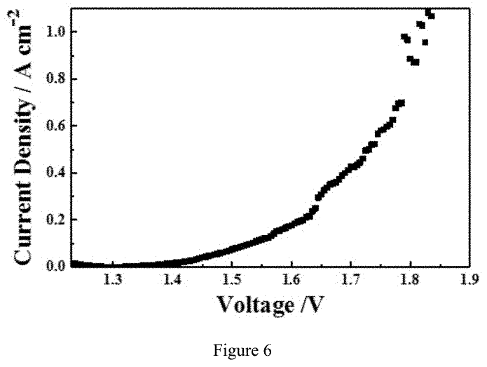

As shown in the electrocatalytic water splitting diagram of FIG. 6, the high entropy alloy NPs synthesized in Example 4 has excellent electrocatalytic activity as bifunctional electrocatalysts.

### Example 5

Example 5 differs from Example 1, 2, 3 and 4 in that it includes the following steps:

(1) Chloroplatinic acid, chloroauric acid, nickel chloride, ferric chloride, and cobalt chloride were dissolved in ethanol with 0.01 M for each metallic element. The mixed solution was directly dropped onto a copper foam with a loading of ˜1 ml/cm². Then the loaded substrates were transferred to a vacuum oven for drying.

(2) The copper foam in step (1) was transferred to a beaker containing hexane (the liquid level was about 1 cm from the bottom of the beaker), and a nanosecond pulse laser with a pulse width of 5 ns was used to scan the surface of the copper foam. The average laser power density was 2×10⁵ W/cm² and the frequency was 20 kHz.

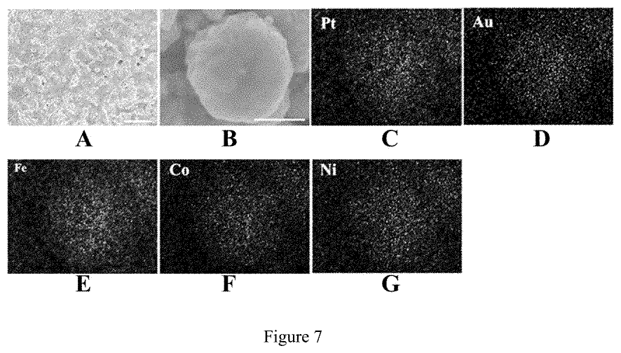

As shown in the micrographs of FIG. 7, the elements of platinum, gold, iron, cobalt, nickel are uniformly dispersed among the high-entropy alloy NPs synthesized from Example 5, while the alloy particles are uniformly distributed on the surface of carbon nanofiber. The average particle size of the high-entropy alloy NPs synthesized in Example 5 is about 700 nm.

### Example 6

Example 6 differs from Example 1, 2, 3, 4 and 5 in that it includes the following steps:

(1) Chloroauric acid, palladium chloride, zinc chloride, copper chloride, and tin chloride were dissolved in ethanol with 0.01 M for each metallic element. The mixed solution was directly dropped onto a glass slide with a loading of ˜1 ml/cm². Then the loaded substrates were transferred to a vacuum oven for drying.

(2) The glass slide in step (1) was transferred to a beaker containing hexane (the liquid level was about 1 cm from the bottom of the beaker), and a nanosecond pulse laser with a pulse width of 5 ns was used to scan the surface of the glass slide. The average laser power density was 2×10⁵ W/cm² and the frequency was 10 kHz.

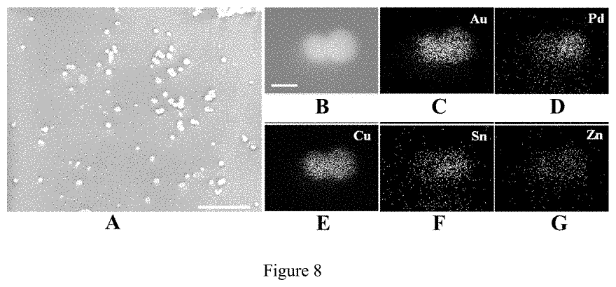

As shown in the micrographs of FIG. 8, the elements of gold, palladium, copper, tin, zinc are uniformly dispersed among the high-entropy alloy NPs synthesized from Example 6, while the alloy particles are uniformly distributed on the surface of carbon nanofiber. The average particle size of the high-entropy alloy NPs synthesized in Example 6 is about 120 nm.

### Example 7

Example 7 differs from Example 1, 2, 3, 4, 5 and 6 in that it includes the following steps:

(1) Copper chloride, chromium chloride, ferric chloride, cobalt chloride, and nickel chloride were dissolved in ethanol with 0.01 M for each metallic element. The mixed solution was directly dropped onto a carbon nanofiber with a loading of ˜1 ml/cm². Then the carbon disulfide solution dissolved in 0.05M sulfur powder was dripped on the carbon nanofiber at a dose of 1 ml/cm². The loaded substrates were transferred to a vacuum oven for drying.

(2) The carbon nanofiber in step (1) was transferred to a beaker containing hexane (the liquid level was about 1 cm from the bottom of the beaker), and a nanosecond pulse laser with a pulse width of 5 ns was used to scan the surface of the carbon nanofiber. The average laser power density was 2×10⁵ W/cm² and the frequency was 10 kHz.

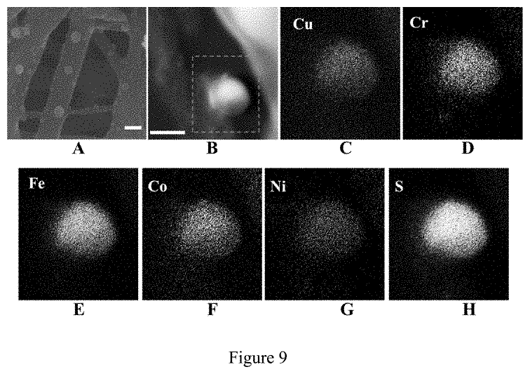

As shown in the micrographs of FIG. 9, the elements of copper, chromium, iron, cobalt, nickel, sulfur are uniformly dispersed among the high-entropy alloy NPs synthesized from Example 7, while the alloy particles are uniformly distributed on the surface of carbon nanofiber.

### Example 8

Example 8 differs from Example 1, 2, 3, 4, 5, 6 and 7 in that it includes the following steps:

(1) Copper chloride, chromium chloride, ferric chloride, cobalt chloride, and nickel chloride were dissolved in ethanol with 0.01 M for each metallic element. The mixed solution was directly dropped onto a carbon nanofiber with a loading of ˜1 ml/cm². Then the sodium hydroxide aqueous solution of 0.05M was dripped on the carbon fiber at a dose of 1 ml/cm². The loaded substrates were transferred to a vacuum oven for drying.

(2) The carbon nanofiber in step (1) was transferred to a beaker containing hexane (the liquid level was about 1 cm from the bottom of the beaker), and a nanosecond pulse laser with a pulse width of 5 ns was used to scan the surface of the carbon nanofiber. The average laser power density was 2×10⁵ W/cm² and the frequency was 10 kHz.

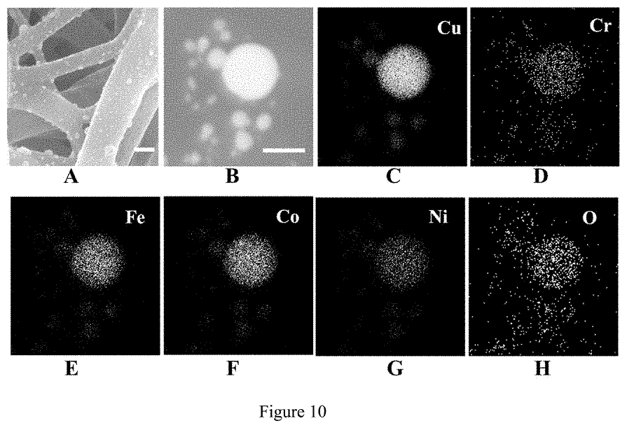

As shown in the micrographs of FIG. 10, the elements of copper, chromium, iron, cobalt, nickel, and sulfur are uniformly dispersed among the high-entropy alloy NPs synthesized from Example 8, while the alloy particles are uniformly distributed on the surface of carbon nanofiber.

### Example 9

Example 9 differs from Example 1, 2, 3, 4, 5, 6, 7 and 8 in that it includes the following steps:

(1) Chloroplatinic acid, chloroauric acid, copper chloride were dissolved in ethanol with 0.01 M for each metallic element. The mixed solution was directly dropped onto a carbon nanofiber with a loading of ˜1 ml/cm². The loaded substrates were transferred to a vacuum oven for drying.

(2) The carbon nanofiber in step (1) was transferred to a beaker containing hexane (the liquid level was about 1 cm from the bottom of the beaker), and a nanosecond pulse laser with a pulse width of 5 ns was used to scan the surface of the carbon nanofiber. The average laser power density was 2×10⁵ W/cm² and the frequency was 10 kHz.

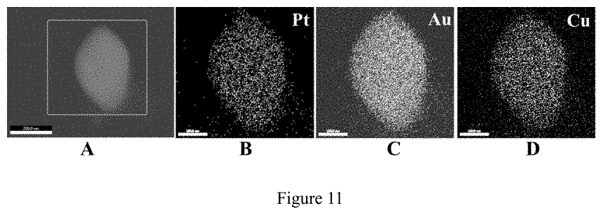

As shown in the micrographs of FIG. 11, the elements of platinum, gold and copper are uniformly dispersed among the medium-entropy alloy NPs synthesized from Example 9.

1. A laser scanning ablation method of synthesizing medium-entropy and high-entropy nanoparticles (NPs), comprising:
step (1) dissolving precursors of each element in medium-entropy or high-entropy NPs in solvent with equal molar ratio or near equal molar ratio to form a solution, and then dripping the solution onto a substrate and dried.
step (2) transferring the substrate in step (1) to a beaker, and irradiated under laser pulse in a liquid phase.

2. According to the laser scanning ablation method of synthesizing medium-entropy and high-entropy NPs mentioned in claim 1, wherein medium-entropy or high entropy NPs involved in step (1) include alloys, oxides, sulfides, phosphides, carbides, nitrides and borides.

3. According to the laser scanning ablation method of synthesizing medium-entropy and high-entropy NPs mentioned in claim 1, wherein the elements of medium-entropy or high-entropy NPs involved in step (1) include platinum, gold, palladium, iridium, ruthenium, rhodium, cesium, copper, chromium, tin, iron, cobalt, nickel, zinc, manganese, vanadium, tantalum, tungsten, rhenium, osmium, hafnium, indium, rubidium, strontium, sulfur, carbon, nitrogen, oxygen, phosphorus, boron, lithium; and
the precursors of each element involved in step (1) include chloride, sulfate, phosphate, nitrate and sulfur powder, phosphorus powder, sodium hypophosphate, sodium borate and hydroxide.

4. According to the laser scanning ablation of synthesizing medium-entropy and high-entropy NPs mentioned in claim 1, wherein the solvent involved in step (1) includes ethanol, methanol, water, acetone, isopropyl alcohol, and carbon disulfide.

5. According to the laser scanning ablation of synthesizing medium-entropy and high-entropy NPs mentioned in claim 1, wherein the substrate involved in step (1) includes carbon, metal, organic and inorganic materials.

6. According to the laser scanning ablation of synthesizing medium-entropy and high-entropy NPs mentioned in claim 1, wherein the liquid phase environment involved in step (2) includes all kinds of alkanes, ethanol, water, methanol, etc.

7. According to the laser scanning ablation of synthesizing medium-entropy and high-entropy NPs mentioned in claim 1, wherein the laser pulse involved in step (2) includes nanosecond lasers and femtosecond lasers.

8. According to the laser scanning ablation of synthesizing medium-entropy and high-entropy NPs mentioned in claim 1, wherein the parameters of the laser involved in step (2) are the power density of 10⁵˜10⁹ W/cm² and the frequency of 1 Hz˜80 kHz; and the wavelength range of the laser covers ultraviolet, visible and infrared light.
